(19) United States
(12) Patent Application Publication
(10) Pub. No.: US 2015/0025924 A1
(43) Pub. Date: Jan. 22, 2015

(54) METHODS OF DISPLAYING INFORMATION TO A USER, AND SYSTEMS AND DEVICES FOR USE IN PRACTICING THE SAME

(71) Applicant: Palo Alto Investors, Palo Alto, CA (US)

(72) Inventors: Anthony Joonkyoo Yun, Menlo Park, CA (US); Jeremy Thomas Yun, Menlo Park, CA (US); Conrad Minkyoo Yun, Chicago, IL (US); Eric Foster Yun, Menlo Park, CA (US)

(21) Appl. No.: 14/328,481

(22) Filed: Jul. 10, 2014

Related U.S. Application Data
(60) Provisional application No. 61/857,184, filed on Jul. 22, 2013.
(60) Provisional application No. 61/857,667, filed on Jul. 23, 2013.
(60) Provisional application No. 61/871,217, filed on Aug. 28, 2013.

(51) Int. Cl. G06Q 10/00

(52) U.S. Cl. CPC G06Q 10/00
USPC 705/7.11

(57) ABSTRACT

Methods of displaying information to a user are provided. Aspects of the methods include receiving information, correlating the received information with one or more factors previously identified as being relevant to the information, deriving a non-linear representation of the information based on the correlation between the information and the one or more factors, displaying a linear representation of the information, and displaying the non-linear representation of the information. Aspects of the invention further include devices and systems for practicing the methods.

### CROSS-REFERENCE TO RELATED APPLICATIONS

This application claims the benefit of U.S. Provisional Application Nos. 61/857,184, filed Jul. 22, 2013; 61/857,667, filed Jul. 23, 2013; and 61/871,217, filed Aug. 28, 2013, which applications are incorporated herein by reference in their entireties and for all purposes.

### INTRODUCTION

The quantity of information currently available to users is unprecedented, and technical advances relating to the provision, receipt and sharing of such information continue to develop at a rapid pace. Of significant importance is the manner in which information is conveyed to a user as this can affect both the actual and perceived value of the information to the user. There are many instances in which information is displayed to a user in a linear fashion. For example, information about the speed at which a car is traveling is displayed to a user, e.g., a driver of the car, in a linear fashion using a speedometer. As another example, information regarding the temperature of an individual, such as a patient, is displayed to a user, e.g., a health care professional or caregiver, in a linear fashion by a thermometer. A linear representation has utility, for example, it may indicate to a user that he or she is exceeding the posted speed limit or that his or her body temperature is above a normal range. However, the linear format is limited and may not provide information to a user in the most valuable or effective way to facilitate a user's decision making process.

### SUMMARY

Methods of displaying information to a user are provided. Aspects of the methods generally include receiving information, correlating the received information with one or more factors previously identified as being relevant to the information, deriving a non-linear representation of the information based on the correlation between the information and the one or more factors, displaying a linear representation of the information, and displaying the non-linear representation of the information. In one embodiment, a method of displaying information to a user is provided, which includes receiving linear, quantitative information; correlating with a computer processor the received linear, quantitative information with one or more factors previously identified as being relevant to the linear, quantitative information; deriving a non-linear representation of the linear, quantitative information based on the correlation between the linear, quantitative information and the one or more factors; displaying a linear representation of the linear, quantitative information; and displaying the non-linear representation of the linear, quantitative information. Aspects of the present disclosure further include devices and systems for practicing the methods.

### BRIEF DESCRIPTION OF THE DRAWINGS

FIG. 1 shows a flow diagram for displaying information to a user according to certain embodiments of the present disclosure.

FIG. 2 shows a flow diagram for displaying health related information to a subject according to certain embodiments of the present disclosure.

FIG. 3 shows a flow diagram for displaying financial information to a user according to certain embodiments of the present disclosure.

FIG. 4 shows a flow diagram for displaying user activity information to a user according to certain embodiments of the present disclosure.

FIG. 5 shows a flow diagram for displaying environmental information to a user according to certain embodiments of the present disclosure.

FIG. 6 illustrates systems for practicing the subject methods according to certain embodiments of the present disclosure.

### DETAILED DESCRIPTION

Methods of displaying information to a user are provided. Aspects of the methods generally include receiving information, correlating the received information with one or more factors previously identified as being relevant to the information, deriving a non-linear representation of the information based on the correlation between the information and the one or more factors, displaying a linear representation of the information, and displaying the non-linear representation of the information. Aspects of the present disclosure further include devices and systems for practicing the methods.

Before the present invention is described in greater detail, it is to be understood that this invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the present disclosure. The upper and lower limits of these smaller ranges may independently be included in the smaller ranges and are also encompassed within the present disclosure, subject to any specifically excluded limit in the stated range. Where the stated range includes one or both of the limits, ranges excluding either or both of those included limits are also included in the present disclosure.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which the present disclosure belongs. Although any methods and materials similar or equivalent to those described herein can also be used in the practice or testing of the disclosed methods, devices and systems, representative illustrative methods and materials are now described. In the event a definition or any disclosure provided herein conflicts with a definition or any disclosure provided in a document incorporated by reference herein, the definition and/or disclosure provided herein shall control.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods for Displaying Information

As summarized above, aspects of the present disclosure include methods of displaying information to a user. By user is meant a consumer of the information, e.g., an individual, such as a human, who receives the information. Aspects of the methods include displaying a non-linear representation of the information to the user. By non-linear representation of the information is meant some representation, i.e., format or configuration, of the information other than a linear format or configuration, e.g., an exponential, logarithmic, recursive format or configuration. A non-linear representation of the information may be configured to provide to the user an understanding of the information that is more meaningful to the user than a linear representation of the information. A non-linear representation of the information as produced herein may vary widely, as described in greater detail below. In some embodiments, a non-linear representation as used herein is a non-linear representation as discussed in U.S. Provisional Application No. 61/857,184, filed Jul. 22, 2013, entitled “Methods of Displaying Information to a User, and Systems and Devices for Use in Practicing Same,” and/or a qualified representation as discussed in U.S. Provisional Application No. 61/857,667, filed Jul. 23, 2013, entitled “Methods of Displaying Information to a User, and Systems and Devices for Use in Practicing Same,” the disclosures of which are incorporated by reference in their entirety herein. A non-linear representation may be characterized as including one or more incremental changes in a value which are not equal in size and/or magnitude to one or more other incremental changes in value in the representation, e.g., in the case of an exponential or logarithmic curve. In other words, a non-linear representation of the information may be a representation that presents the information to a user in a manner that varies depending on the magnitude of a given value of the information.

Aspects of the methods include deriving a non-linear representation of the information from linear, quantitative information. By linear, quantitative information is meant a set of values which can be described linearly. For example, linear, quantitative information may be characterized as a set of quantitative values wherein every numerical, incremental change in value is equal in size and/or magnitude. A linear representation of the information is a representation that presents the information to a user in a manner that is constant regardless of the magnitude of a given value of the information. For example, a speedometer provides information about the speed of a car in a linear representation because the numbers on the speedometer do not change in appearance or format as the speed of the vehicle changes, but instead are presented in the same font and size on the speedometer to the user, e.g., the driver. The numbers on the speedometer are quantitative measures of the information, i.e., the speed at which the car is traveling.

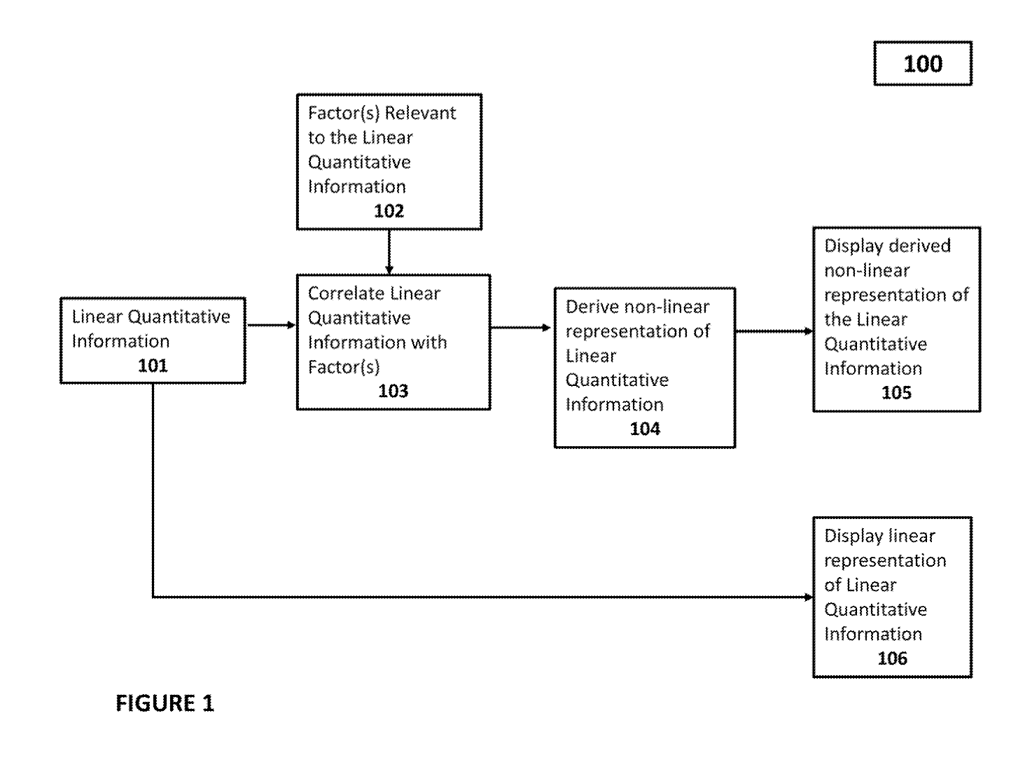

In some embodiments, a method of displaying information according to the present disclosure is a method (100) as depicted by the flow diagram of FIG. 1. The method generally includes the steps of: receiving linear, quantitative information (101), correlating (103) the received linear, quantitative information with one or more factors (102) previously identified as being relevant to the information, deriving a non-linear representation of the information based on the correlation between the information and the one or more factors (104), displaying a linear representation of the information (106), and displaying the non-linear representation of the information (105).

In some instances, a computer processor is employed to derive the non-linear representation of the linear, quantitative information. A computer processor may be configured to perform one or more of the following functions: (1) receiving linear, quantitative information; (2) correlating the received linear, quantitative information with one or more factors previously identified as being relevant to the linear, quantitative information; (3) deriving a non-linear representation of the linear, quantitative information based on the correlation between the linear, quantitative information and the one or more factors; (4) causing a display to display a linear representation of the linear, quantitative information; and (5) causing a display to display the non-linear representation of the linear, quantitative information. In some embodiments, one or more of the above functions may be performed by a processor as described in U.S. Provisional Application No. 61/857,184, filed Jul. 22, 2013 and/or a qualifier module as described in U.S. Provisional Application No. 61/857,667, filed Jul. 23, 2013, entitled “Methods of Displaying Information to a User, and Systems and Devices for Use in Practicing Same,” and previously incorporated by reference herein.

The one or more factors employed by the computer processor to correlate with the received linear, quantitative information and thereby derive a non-linear representation of the linear, quantitative information may be selected from a variety of different types of data, including, e.g., information as described in U.S. Provisional Application No. 61/857,184, filed Jul. 22, 2013 and/or qualifying data as described in U.S. Provisional Application No. 61/857,667, filed Jul. 23, 2013, entitled “Methods of Displaying Information to a User, and Systems and Devices for Use in Practicing Same,” and previously incorporated by reference herein. In some embodiments, the one or more factors may be selected from a database including data previously identified as being relevant to the linear, quantitative information.

In some instances, the one or more factors comprise risk data. By risk data is meant information about a given risk, i.e., probability of an adverse event occurring, for a given quantitative measure. For example, the one or more factors may include a set of risk values that have been predetermined and are associated with different speeds of a car. Specifically, a database may include a risk value x which is associated with a speed of 65 mph, a risk value y which is associated with a speed of 75 mph and a risk value z which is associated with a speed of 80 mph. Another type of data which may be utilized by a computer processor to derive a non-linear representation is relevance data. For example, a database accessibly by the processor may include a predetermined relevance rating for given quantitative measures of information. For example, where the quantitative measure is a date and time, a database may include data regarding the relevance of different dates and times, e.g., whether a given difference in two rates/times is relevant or not. Yet another type of data which may be utilized is reward data. For example, a given database may include predetermined reward factors for a given associated salary level, where the reward factors may include components of predicted happiness from additional money, predicted extra time required to obtain the extra money, etc.

In some embodiments, the received linear, quantitative information is correlated with a plurality factors previously identified as being relevant to the linear, quantitative information. For example, a correlation with 2, 3, 4, 5, 10, 100, 1000 or more factors may be used by the processor to derive a non-linear representation of the linear, quantitative information. For example, derivation of the non-linear representation may take into account a correlation between speed of a vehicle, location of the vehicle, time of day, and risk of accident.

Factors used to correlate with the linear, quantitative information to derive the displayed non-linear representation of the linear, quantitative information may originate from a variety of sources, e.g., a vehicle's on-board computer system; e.g., an on-board GPS system; one or more vehicle sensors; and one or more databases, e.g., a database of the National Highway traffic Safety Administration, Merck index, Physicians' Desk Reference, National Institute of Health, Center for Disease Control, Farmers' Almanac, Environmental Protection Agency, Food and Drug Administration, Business Plans Handbook, Consumer Health Reports, U.S. Stock databases, U.S. real estate databases, among other sources of information. The number and source of the various factors may vary significantly depending on the particular context in which the information is being provided to a user.

As evidenced by the description and examples provided herein, the available dataset used to correlate with the linear, quantitative information and derive a non-linear representation may include non-linear information. The non-linear information may be information that is produced using a variety of different approaches, such as but not limited to: logarithmic, exponential, recursive, etc.

A variety of different types of information may be displayed in accordance with the methods of the present disclosure, including, e.g., health-related information, financial information, user-activity related information and environmental information. Certain non-limiting examples of these information types and their applicability to the disclosed methods are described below.

### Health-Related Information

An effective display of health-related information can facilitate important medical and other health related decisions by a user or a subject, e.g., a patient or health care provider. Information that may be displayed in accordance with the disclosed methods may include, e.g., information regarding the physiological state of a living organism. Examples of physiological state information include, but are not limited to: temperature, weight, blood pressure, pulse rate, respiratory rate, blood oxygen saturation, cardiac output, pulmonary output, brain activity, physiological concentrations of glucose, glycated hemoglobin, cholesterol, low-density lipoprotein, high-density lipoprotein, triglyceride, blood urea nitrogen, ions and metals (such as magnesium, calcium, sodium, potassium, nitrite, phosphate, chloride, bicarbonate, etc.) arterial blood gases (e.g., oxygen, carbon dioxide, etc.), protein and enzymes (e.g., human chorionic gonadotropin), blood components (red blood cells, white blood cells, hemoglobin) as well as other compounds such as bilirubin, ketone bodies, urobilinogen, catecholamines, cortisol, phenylalanine, etc.

In some embodiments, physiological information may be derived based on linear, quantitative information obtained using any conventional protocol for obtaining physiological information such as for example, biochemical analysis of a biological fluid such as blood, plasma, serum, pulmonary fluid, cerebrospinal fluid, lymph, tears, saliva, urine, semen, vaginal fluids, amniotic fluid, cord blood, mucus, synovial fluid, tissue and tissue sections. Alternatively, physiological information may be obtained directly from a subject using conventional medical equipment such as a sphygmomanometer, blood gas monitors, pulse oximeters, electrocardiographs, thermometer (e.g., tympanic thermometers), etc.

Health related information may be displayed in accordance with the present disclosure as a non-linear representation derived based on a correlation of linear, quantitative information with specific secondary factors previously identified as being relevant to the linear, quantitative information. Depending on the particular health information to be displayed, secondary factors may include, but are not limited to age, weight, height, body mass index, hair color, gender, race, genetic predispositions (such as determined by single nucleotide polymorphism (SNPs) analysis or genetic screenings), diet, exercise, family history, existing disease or abnormal conditions, use of prescription or non-prescription medication, previous surgical procedures, work environment, living conditions, occupation, overall health, stress factors, among other secondary factors.

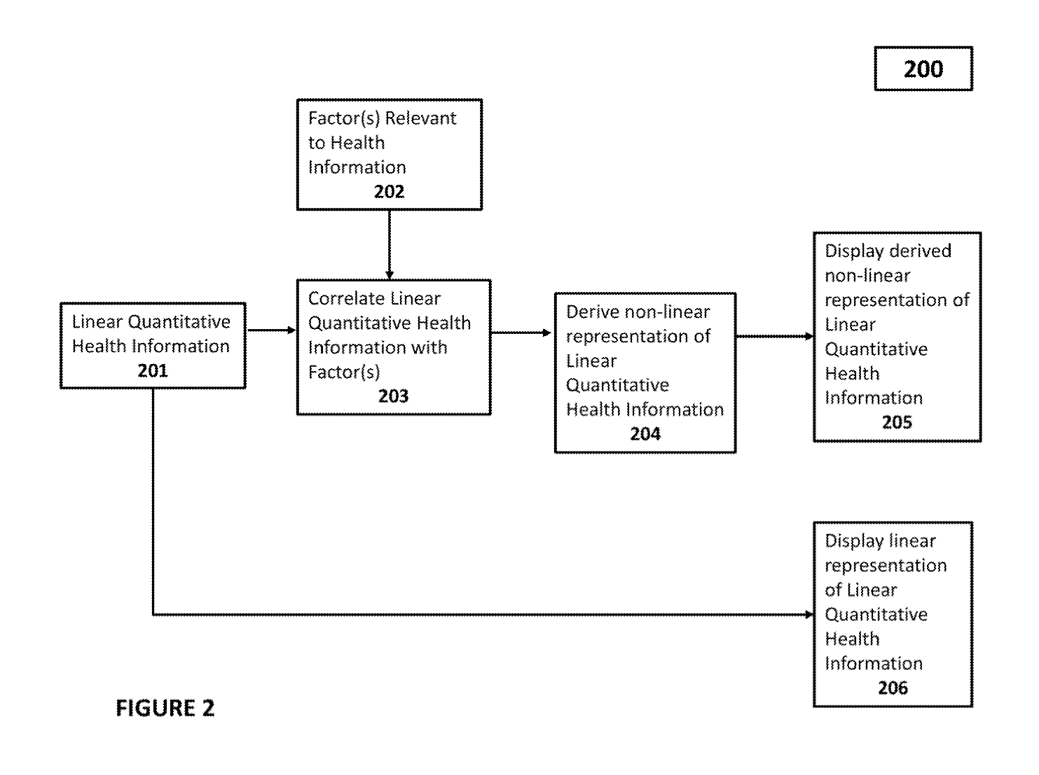

In some embodiments, a method of displaying health-related information according to the present disclosure is a method (200) as depicted by the flow diagram of FIG. 2. The method generally includes the steps of: receiving linear, quantitative health-related information (201), correlating (203) the received linear, quantitative health-related information with one or more factors (202) previously identified as being relevant to the information, deriving a non-linear representation of the health-related information based on the correlation between the health-related information and the one or more factors (204), displaying a linear representation of the health-related information (206), and displaying the non-linear representation of the health-related information (205).

In some instances, a computer processor is employed to derive a non-linear representation of linear, quantitative health related information. A computer processor may be configured to perform one or more of the following functions: (1) receiving linear, quantitative health related information; (2) correlating the received linear, quantitative health related information with one or more factors previously identified as being relevant to the linear, quantitative health related information; (3) deriving a non-linear representation of the linear, quantitative health related information based on the correlation between the linear, quantitative health related information and the one or more factors; (4) causing a display to display a linear representation of the linear, quantitative health related information; and (5) causing a display to display the non-linear representation of the linear, quantitative health related information.

One or more of the above secondary factors may be correlated with the linear data to derive the non-linear representation to be displayed, e.g., to the subject, such as 2 or more secondary factors, such as 3 or more secondary factors, such as 5 or more secondary factors, such as 10 or more secondary factors and including 25 or more secondary factors as desired. For example, the number of secondary factors employed to derive the non-linear representation may range from 1 to 50, such as from 2 to 45, such as from 5 to 40, such as from 10 to 35, such as from 15 to 30 and including from 20 to 30 secondary factors.

Non-linear representations may depend on the number and type of secondary factors correlated with the linear data. As such, methods according to certain embodiments include adjusting the number or type of secondary factors. By “adjusting” is meant increasing or decreasing the number or changing the type of secondary factors correlated with the linear data. Depending on the display protocol, the non-linear representation may be changed in real time or may be changed based on input in a separate distinct analysis.

For example, in one embodiment a thermometer which includes a conventional temperature scale may be employed to display the temperature of a subject in the form of a linear representation. The linear representation in certain instances may be a numerical value or a table of numerical values over the course of a period of time. In these embodiments, the thermometer also displays a non-linear representation of the temperature of the subject which takes into consideration one or more factors related to and of significance to a subject's temperature. For example, the non-linear representation of the physiological temperature of a subject may be derived based on a correlation of the linear temperature data with specific data about the subject, such as age, weight, body mass index, gender, diet and exercise history as well as any existing disease or physiological conditions to provide a non-linear representation about the subject's temperature.

The non-linear representation may be displayed as an assessment (i.e., report) which presents the linear, quantitative temperature data in the context of the secondary factors. This may take the form of a risk assessment (such as for a disease or physiological abnormality) or an escalation of possible indications based on the linear, quantitative temperature information coupled with the one or more factors. Alternatively, the non-linear representation may be derived based on a correlation of the secondary factors with the linear data and present an indication that the linear, quantitative data is “normal” when taken in context with the secondary factors. In certain instances, the non-linear representation is a circle that gets increasingly larger and/or changes color from green through yellow to red in an exponential manner as the temperature increases or decrease beyond a predetermined safe value, e.g., 98.5° F. For instance, where the secondary factor is age, the non-linear representation may display an increased escalation of urgency based on a predetermined threshold of age. For example, the non-linear representation may display a “green” color where physiological temperature of an 18 year old subject has increased to greater than 99° F., whereas the non-linear representation may display a “red” color where the physiological temperature of a 65 year old subject or an infant has increased to greater than 99° F.

In another embodiment, a body weight scale which includes a conventional weight scale may be employed to display the weight of a subject in the form of a linear representation. The linear representation in certain instances may be a numerical value or a table of numerical values over the course of a period of time. In these embodiments, the body weight scale also displays a non-linear representation of the subject's body weight which takes into consideration one or more factors related to and of significance to a subject's body weight. For example, the non-linear representation of the weight of a subject may be derived based on a correlation of the linear weight data with specific data about the subject, such as age, body mass index, gender, genetic predispositions (such as determined by single nucleotide polymorphism (SNPs) analysis or genetic screenings), obesity or malnutrition familial history, diet and exercise history as well as any existing disease or physiological conditions to provide a non-linear representation about the subject's body weight.

The non-linear representation may be displayed as an assessment (i.e., report) which presents the linear, quantitative body weight data in the context of the secondary factors. This may take the form of a risk assessment (such as for a disease or physiological abnormality) or an escalation of possible indications based on the linear, quantitative body weight information coupled with the one or more factors. Alternatively, the non-linear representation may be derived based on a correlation of the secondary factors with the linear data and present an indication that the linear, quantitative data is “normal” when taken in context with the secondary factors. In certain instances, e.g., the non-linear representation is a circle that gets increasingly larger and/or changes color from green through yellow to red in an exponential manner as the weight increases beyond a predetermined safe value, e.g., 150 lbs. For instance, where the secondary factor is a familial history of obesity, the non-linear representation may display an increased escalation of urgency depending on the presence of absence of a familial history of obesity. For example, the non-linear representation may display a “green” color where body weight of a subject without a familial history of obesity is 160 pounds, whereas the non-linear representation may display a “red” color where the body weight of a subject with a familial history of obesity is 160 pounds. Likewise, in some instances the secondary factor is the height of the subject, the non-linear representation may display an assessment of the subject's body weight in the context of the subject's height to present a non-linear representation of the subject's body weight. In these examples, the non-linear representation may display an animated caricature of the subject indicating that the body weight is normal or abnormal when evaluated in the context of the subject's height.

In another embodiment, a body mass index (BMI) measuring device may be employed to display BMI information to a subject according to the disclosed methods. The linear representation in certain instances may be a numerical value or a table of numerical values over the course of a period of time. In these embodiments, the body mass index also displays a non-linear representation of the subject's body mass index which takes into consideration one or more factors related to and of significance to a subject's body mass index. For example, the non-linear representation of the body mass index of a subject may be derived based on a correlation of the linear body mass index data with specific data about the subject, such as age, gender, genetic predispositions (such as determined by single nucleotide polymorphism (SNPs) analysis or genetic screenings), obesity or malnutrition familial history, diet and exercise history as well as any existing disease or physiological conditions to provide a non-linear representation of the subject's body mass index.

The non-linear representation may be displayed as an assessment (i.e., report) which presents the linear, quantitative body mass index data in the context of the secondary factors. This may take the form of a risk assessment (such as for a disease or physiological abnormality) or an escalation of possible indications based on the linear, quantitative body mass index information coupled with the one or more factors. Alternatively, the non-linear representation may be derived based on a correlation of the secondary factors with the linear data and present an indication that the linear, quantitative body mass index data is “normal” for the particular subject when taken in context with the secondary factors. For instance, where the secondary factor is a familial history of obesity, the non-linear representation may display an increased escalation of urgency depending on the presence of absence of a familial history of obesity. For example, the non-linear representation may display a “green” color where body mass index of a subject without a familial history of obesity is 25, whereas the non-linear representation may display a “red” color where the body mass index of a subject with a familial history of obesity is greater than 25. Alternatively, the non-linear representation may display a “green color” to a subject where the body mass index of the subject without a familial history of diabetes is greater 25, whereas the non-linear representation may display a “red” color where the body mass index of a subject with a familial history of diabetes is greater than 25. In other instances, the non-linear representation of body mass index may be an animated caricature of the subject indicating that the body mass index is normal or abnormal when evaluated in the context of secondary factors such as diet and exercise history, familial history of obesity, diabetes, etc. or dietary considerations.

In another embodiment, a blood glucose monitor which includes a conventional blood glucose meter may be employed to display the blood glucose concentration of a subject in the form of a linear representation. The linear representation in certain instances may be a numerical value or a table of numerical values over the course of a period of time. In these embodiments, the blood glucose meter also displays a non-linear representation of the blood glucose concentration of the subject which takes into consideration one or more factors related to and of significance to a subject's blood glucose concentration. For example, the non-linear representation of the blood glucose concentration of a subject may be derived based on a correlation of the linear blood glucose concentration data with specific data about the subject, such as age, weight, body mass index, gender, diet and exercise history as well as any existing disease or physiological conditions to provide a non-linear representation about the subject's blood glucose concentration.

The non-linear representation may be displayed as an assessment (i.e., report) which presents the linear, quantitative blood glucose concentration data in the context of the secondary factors. This may take the form of a risk assessment (such as for diabetes) or an escalation of possible indications based on the linear, quantitative blood glucose concentration information coupled with the one or more factors. Alternatively, the non-linear representation may be derived based on a correlation of the secondary factors with the linear data and present an indication that the linear, quantitative data is “normal” when taken in context with the secondary factors. In certain instances, the non-linear representation is a circle that gets increasingly larger and/or changes color from green through yellow to red in an exponential manner as the blood glucose concentration increases or decrease beyond a predetermined safe value, e.g., 100 mg/dl. For instance, where the secondary factor is age, the non-linear representation may display an increased escalation of urgency based on a predetermined threshold of age. For example, the non-linear representation may display a “green” color where the pre-meal blood glucose concentration of a 6-12 year old child is 160 mg/dl, whereas the non-linear representation may display a “red” color where the pre-meal blood glucose concentration of an adult is 160 mg/dl.

In another embodiment, cholesterol levels are conveyed to a subject by methods of the present disclosure. The linear representation of cholesterol levels in certain instances may be displayed as a numerical value or a table of numerical cholesterol values over the course of a period of time. In these embodiments, the cholesterol levels are also displayed as a non-linear representation of cholesterol levels of the subject taking into consideration one or more secondary factors related to and of significance to a subject's cholesterol levels. For example, the non-linear representation of the cholesterol level of a subject may be based on a correlation of the linear cholesterol data with specific data about the subject, such as age, weight, body mass index, gender, diet and exercise history as well as any existing disease or physiological conditions (e.g., coronary heart disease).

The non-linear representation may be displayed as an assessment (i.e., report) which presents the linear, quantitative cholesterol data in the context of the secondary factors. This may take the form of a risk assessment (such as for coronary heart disease or stroke) or an escalation of possible indications based on the linear, quantitative cholesterol information coupled with the one or more factors. Alternatively, the non-linear representation may be derived based on a correlation of the secondary factors with the linear data and present an indication that the linear, quantitative data is “normal” when taken in context with the secondary factors. In certain instances, the non-linear representation is a circle that gets increasingly larger and/or changes color from green through yellow to red in an exponential manner as the cholesterol level increases or decrease beyond a predetermined safe range, e.g., 150 to 200 mg/dL of total cholesterol. For instance, where the secondary factor is body mass index, the non-linear representation may be a display of an increased escalation of urgency in cholesterol levels when in the context of a range of body mass indices. For example, the non-linear representation may display a “green” color where cholesterol of a subject with normal body mass index has increased to greater than 200 mg/dL, whereas the non-linear representation may display a “red” color where the cholesterol level of a subject with a higher than normal body mass index has increased to greater than 180 mg/dL.

In yet another embodiment, blood pressure may be conveyed to a subject by methods of the present disclosure. The linear representation of blood pressure in certain instances may be displayed as a numerical value or a table of numerical blood pressure values over the course of a period of time. In these embodiments, blood pressure is also displayed as a non-linear representation of blood pressure of the subject taking into consideration one or more secondary factors related to and of significance to a subject's blood pressure. For example, the non-linear representation of the blood pressure of a subject may be based on a correlation of the linear blood pressure data with specific data about the subject, such as age, weight, body mass index, gender, diet and exercise history as well as any prescription or non-prescription drug use (e.g., anti-hypertensives).

The non-linear representation may be displayed as an assessment (i.e., report) which presents the linear, quantitative blood pressure data in the context of the secondary factors. This may take the form of a risk assessment (such as for stroke) or an escalation of possible indications based on the linear, quantitative blood pressure information coupled with the one or more factors. Alternatively, the non-linear representation may be derived based on a correlation of the secondary factors with the linear data and present an indication that the linear, quantitative data is “normal” when taken in context with the secondary factors. In certain instances, the non-linear representation is a circle that gets increasingly larger and/or changes color from green through yellow to red in an exponential manner as the blood pressure level increases or decrease beyond a predetermined safe range, e.g., a systolic blood pressure of 120 to 180 mm Hg or a diastolic blood pressure of 50 to 80 mm Hg. For instance, where the secondary factor is body mass index, the non-linear representation may be a display of an increased escalation of urgency in blood pressure when in the context of a range of body mass indices. For example, the non-linear representation may display a “green” color where systolic blood pressure of a subject with normal body mass index has increased to greater than 180 mm Hg, whereas the non-linear representation may display a “red” color where the systolic blood pressure of a subject with a higher than normal body mass index has increased to greater than 150 mm Hg.

Like the above examples, non-linear representations of linear, quantitative information may be displayed in accordance with methods of the invention relating to any number and type of health related data which is conventionally conveyed to a subject as linear, quantitative data. For example, other types of physiological state information that may be conveyed to a subject in accordance with the subject methods include, but are not limited to blood pressure, pulse rate, respiratory rate, blood oxygen saturation, cardiac output, pulmonary output, brain activity, low-density lipoprotein, high-density lipoprotein, triglyceride, blood urea nitrogen, ions and metals (such as magnesium, calcium, sodium, potassium, nitrite, phosphate, chloride, bicarbonate, etc.) arterial blood gases (e.g., oxygen, carbon dioxide, etc.), protein and enzymes (e.g., human chorionic gonadotropin), blood components (red blood cells, white blood cells, hemoglobin), glycated hemoglobin as well as other compounds such as bilirubin, ketone bodies, urobilinogen, catecholamines, cortisol, phenylalanine, among others.

In certain embodiments, the disclosed methods include displaying information about more than one physiological state, such as two or more physiological states, such as three or more physiological states and including 5 or more physiological states. In certain instances, methods include displaying between 2 and 10 physiological states to a subject, such as 3 to 9 physiological states, such as 4 to 8 physiological states and including displaying between 5 to 7 physiological states to a subject. This may be accomplished for example using a display (e.g., video monitor) which has 2 separate displays, split screens or sections to display linear and non-linear representations of the physiological state information, such as in a display at a nurse's station or in a patient room in a hospital or medical clinic. Non-linear representations displayed together pertaining to each of the physiological states may be based on correlations with the same or different secondary factors or a combination thereof. For example one or more of the non-linear representations may be based on a correlation of age, weight, height, body mass index, gender and existing health conditions with linear, quantitative data about that physiological condition. In other instances, two more of the plurality of displayed non-linear representations may be based on a correlation of the secondary factors of age and weight with the linear, quantitative health information data. In yet other instances, two or more of the plurality of displayed non-linear representations may be based on a correlation of the secondary factors of height and existing health conditions with the linear quantitative health information data.

### Financial Information

Another area where the disclosed methods, systems and devices find particularly utility is in the display of financial information. By “financial information” is meant data associated with one or more financial product, investment or tool. Examples of financial information may include, but are not limited to information about stocks, bonds, cash, real estate, treasury notes, mutual funds, hedge funds, venture capital, stock options, commodities, insurance products (such as annuities), commodities futures, equity futures, derivatives such as collaterized debt, precious metals, antiques, coins, stamps, and combinations thereof. In some embodiments, financial information may also include the price of an item or service.

Financial information displayed in accordance with the present disclosure includes a non-linear representation derived based on a correlation of the linear financial data with specific secondary factors previously identified as being relevant to the linear, quantitative financial information. Depending on the particular financial information conveyed, secondary factors may include, but are not limited to market history, volatility, age of security, market region, market sector, company stability, current market trading value, interest rates, foreign market share, inflation and deflation, government regulation, current world events, exchange rates impending launch of new products, FDA approval, press-releases of information from company, filing and issuance of key patents, impending or threatened litigation, among other secondary factors.

One or more of the above secondary factors may be correlated with the linear financial data to derive the non-linear representation displayed, such as 2 or more secondary factors, such as 3 or more secondary factors, such as 5 or more secondary factors, such as 10 or more secondary factors and including 25 or more secondary factors as desired. For example, the number of secondary factors employed to derive the non-linear representation may range from 1 to 50, such as from 2 to 45, such as from 5 to 40, such as from 10 to 35, such as from 15 to 30 and including from 20 to 30.

Non-linear representations may depend on the number and type of secondary factors correlated with the linear financial data. As such, methods according to certain embodiments include adjusting the number or type of secondary factors. Depending on the display protocol, the non-linear representation may be changed in real time or may be changed based on input in a separate distinct analysis.

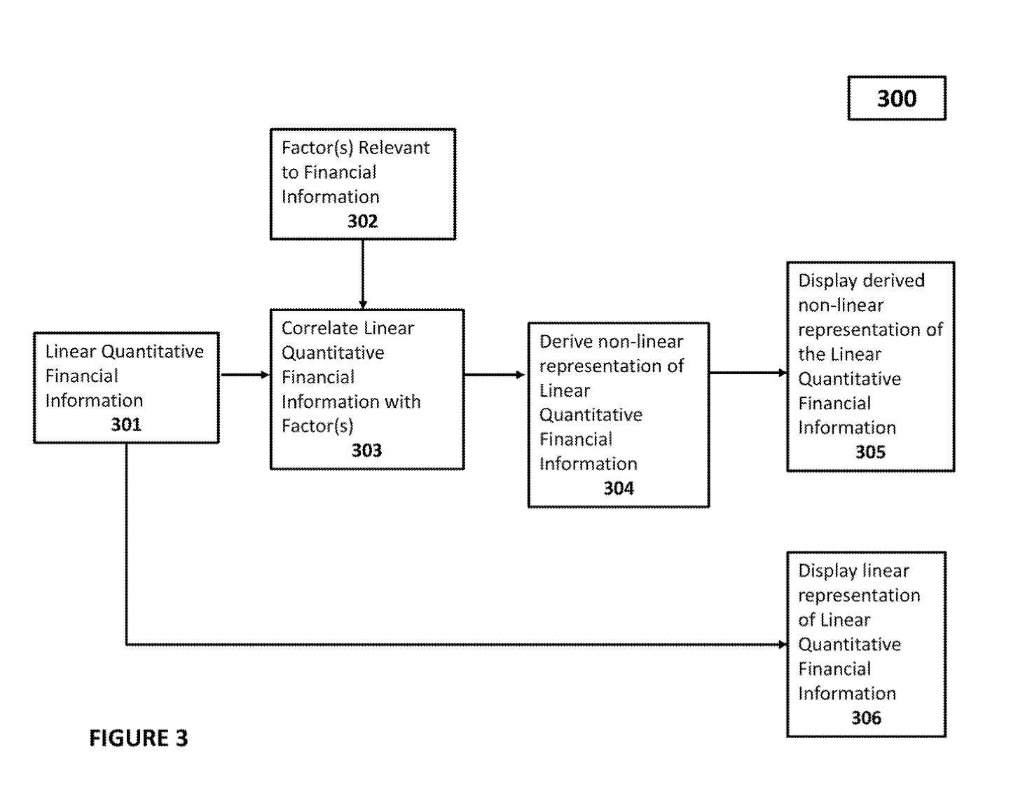

In some embodiments, a method of displaying financial information according to the present disclosure is a method (300) as depicted by the flow diagram of FIG. 3. The method generally includes the steps of: receiving linear, quantitative financial information (301), correlating (303) the received linear, quantitative financial information with one or more factors (302) previously identified as being relevant to the information, deriving a non-linear representation of the financial information based on the correlation between the financial information and the one or more factors (304), displaying a linear representation of the financial information (306), and displaying the non-linear representation of the financial information (305).

In some instances, a computer processor is employed to derive a non-linear representation of linear, quantitative financial information. A computer processor may be configured to perform one or more of the following functions: (1) receiving linear, quantitative financial information; (2) correlating the received linear, quantitative financial information with one or more factors previously identified as being relevant to the linear, quantitative financial information; (3) deriving a non-linear representation of the linear, quantitative financial information based on the correlation between the linear, quantitative financial information and the one or more factors; (4) causing a display to display a linear representation of the linear, quantitative financial information; and (5) causing a display to display the non-linear representation of the linear, quantitative financial information.

For example, in one embodiment the market value of a precious metal (e.g., gold, silver, copper, platinum, etc.) may be conveyed to the user by methods of the invention. The linear representation of the market value of the precious metal, in certain instances, may be displayed as a numerical value or a table of numerical values over the course of a period of time. In these embodiments, the precious metal market value is also displayed as a non-linear representation of precious metal market value taking into consideration one or more secondary factors related to and of significance to precious metal market value. For example, the non-linear representation of the precious metal market value may be based on a correlation of the linear precious metal market value data with specific secondary market factors such as current government regulation, interest rates, historical trading prices, trends in stock and bond trading, inflation rates and foreign investor interest.

The non-linear representation may be displayed as an assessment (i.e., report) which presents the linear, quantitative precious metal market value data in the context of the secondary factors. This may take the form of an investment risk assessment (alone or as a part of an investment portfolio) or as a depiction of long-term projected outlook for the market value of the specific precious metal. In certain instances, the non-linear representation is presented as a gradient that changes colors in a non-linear manner as the market value of the precious metal increases or decreases below a predetermined threshold, such as a fixed investment price or some historical value. In some instances, where one secondary factor is stock market stability, the non-linear representation may be a display of increased escalation of investment risk when in the context of stock market stability. For example, the non-linear representation may be a flashing red light when the price of gold has increased above 1000 US dollars per ounce when correlated with high stock market stability. On the other hand, the non-linear representation may be a flashing green light when the price of gold has decreased below 1000 US dollars per ounce when correlated with low stock market stability. In other words, the non-linear representation may be provided by correlating the linear, quantitative market value data for gold with a secondary factor such as stock market stability and generating an exponential or other non-linear assessment of current gold value based on the correlation.

In another embodiment, private real estate market information (e.g., list, offer or sale prices for single family homes, townhouses, condominiums, etc.) may be conveyed to a subject by methods of the present disclosure. The linear representation of the average price of private real estate in certain instances may be displayed as a numerical value or a linear trend of numerical values. In these embodiments, the private real estate market information is also displayed as a non-linear representation of private real estate market prices taking into consideration one or more secondary factors related to and of significance to the private real estate market. For example, the non-linear representation of the private real estate market may be based on a correlation of the linear private real estate market data with specific secondary market factors such as geographic location, interest rates, government subsidies, historical sale prices of equivalent homes, inflation rates and foreign investor interest.

The non-linear representation may be displayed as an assessment (i.e., report) which presents the linear, quantitative private real estate market data in the context of the secondary factors. This may take the form of an investment risk assessment (alone or as a part of an investment portfolio) or as a depiction of long-term projected outlook for the private real estate market. In certain instances, the non-linear representation is presented as a gradient that changes colors in a non-linear manner as the private real estate market increases or decreases above or below a predetermined threshold, such as a fixed price or some historical value. In some instances, where one secondary factor is interest rates, the non-linear representation may be a display of increased escalation of investment risk when in the context of interest rates. For example, the non-linear representation may be a flashing red light when the average price of single family homes in a particular geographic region has increased above a predetermined threshold when correlated with lower than average interest rates. On the other hand, the non-linear representation may be a flashing green light when the average price of single family homes in a particular geographic region has decreased below a predetermined threshold when correlated with lower than average interest rates. In other words, the non-linear representation is derived by correlating the linear, quantitative private real estate market data with one or more secondary factors such as interest rates and generating an exponential or other non-linear assessment of current private real estate market.

In another embodiment, specific stock price information (e.g., Apple® or Facebook® stock) may be conveyed to a subject by methods of the invention. The linear representation of the stock price information in certain instances, may be displayed as a numerical value or a linear trend of numerical values. In these embodiments, the stock price information is also displayed as a non-linear representation of stock prices taking into consideration one or more secondary factors related to and of significance to the stock market, or the specific stock in question. For example, the non-linear representation of the stock price may be based on a correlation of the linear stock price data with specific secondary market factors such as interest rates, government subsidies, media interest, investor interest, inflation rates and foreign investor interest.

The non-linear representation may be displayed as an assessment (i.e., report) which presents the linear, quantitative stock price data in the context of the secondary factors. This may take the form of an investment risk assessment (alone or as a part of an investment portfolio) or as a depiction of long-term projected outlook for the specific stock. In certain instances, the non-linear representation is presented as a gradient that changes colors in a non-linear manner as the stock price increases or decreases above or below a predetermined threshold, such as a fixed price or some historical value. In some instances, where one secondary factor is investor interest, the non-linear representation may be a display of increased escalation of investment risk when in the context of investor interest. For example, the non-linear representation may be a flashing red light when the stock price has increased above a predetermined threshold when correlated with declining investor interest. On the other hand, the non-linear representation may be a flashing green light when the stock price has decreased below a predetermined threshold when correlated with increasing investor interest. In other words, the non-linear representation is derived by correlating the linear, quantitative stock price data with one or more secondary factors such as investor interest and generating an exponential or other non-linear assessment of the stock price.

In another embodiment, specific commodities futures price information may be conveyed to a subject by methods of the invention. The linear representation of the commodities futures price information in certain instances, may be displayed as a numerical value or a linear trend of numerical values. In these embodiments, the commodities future price information is also displayed as a non-linear representation of commodities futures prices taking into consideration one or more secondary factors related to and of significance to the market for the specific commodities future. For example, the non-linear representation of the commodities futures price may be based on a correlation of the linear commodities futures price data with specific secondary market factors such as media interest, supply of specific commodity, geographic importance of commodity, interest rates, government subsidies and foreign investor interest.

The non-linear representation may be displayed as an assessment (i.e., report) which presents the linear, quantitative commodities futures price data in the context of the secondary factors. This may take the form of an investment risk assessment (alone or as a part of an investment portfolio) or as a depiction of long-term projected outlook for the specific commodity future. In certain instances, the non-linear representation is presented as a gradient that changes colors in a non-linear manner as the commodities future price increases or decreases above or below a predetermined threshold, such as a fixed price or some historical value. In some instances, where one secondary factor is the presence or absence of existing government subsidies, the non-linear representation may be a display of increased escalation of investment risk when in the context of the presence of absence of existing government subsidies. For example, the non-linear representation may be a flashing red light when the commodities futures price has increased above a predetermined threshold when correlated with existing government subsidies. On the other hand, the non-linear representation may be a flashing green light when the commodities futures price has decreased below a predetermined threshold when correlated with little to no existing government subsidies. In other words, the non-linear representation is derived by correlating the linear, quantitative commodities futures price data with one or more secondary factors such as the presence or absence of existing government subsidies and generating an exponential or other non-linear assessment of the commodities futures price.

In yet another embodiment, mutual fund information may be conveyed to a subject by methods of the invention. The linear representation of the mutual fund information in certain instances, may be displayed as a numerical value or a linear trend of numerical values. In these embodiments, the mutual fund information is also displayed as a non-linear representation of mutual fund data taking into consideration one or more secondary factors related to and of significance to the market for the mutual fund. For example, the non-linear representation of the mutual fund may be based on a correlation of the linear mutual fund data with specific secondary market factors such as fund manager, reputation of brokerage managing the mutual fund, assets of mutual fund portfolio, interest rates and media interest.

The non-linear representation may be displayed as an assessment (i.e., report) which presents the linear, quantitative mutual fund data in the context of the secondary factors. This may take the form of an investment risk assessment (alone or as a part of an investment portfolio) or as a depiction of long-term projected outlook for the mutual fund. In certain instances, the non-linear representation is presented as a gradient that changes colors in a non-linear manner as the price of the mutual fund increases or decreases above or below a predetermined threshold, such as a fixed price or some historical value. In some instances, where one secondary factor is the reputation of the fund manager, the non-linear representation may be a display of increased escalation of investment risk when in the context of the existing reputation of the fund manager. For example, the non-linear representation may be a flashing red light when the mutual fund price has increased above a predetermined threshold when correlated with negative reviews of the existing manager of the mutual fund. On the other hand, the non-linear representation may be a flashing green light when the mutual fund price has decreased below a predetermined threshold when correlated with positive reviews of the existing manager of the mutual fund. In other words, the non-linear representation is derived by correlating the linear, quantitative mutual fund data with one or more secondary factors such as the reputation of the current mutual fund manager and generating an exponential or other non-linear assessment of the mutual fund.

Yet another type of information that can be displayed to a user is information about an asset. An example of such information is information about the value of the asset. For example, the stock price may be presented to a user as a given value, based on a linear scale, e.g., from 1 to 1000 dollars. In addition, a non-linear representation of the price may also be presented to the user, e.g., as a shape or color that indicates a percentage change from the previous closing price of the stock so that more meaningful information may be imparted to the user.

Like the above examples, non-linear representations of linear, quantitative information may be displayed in accordance with methods of the invention relating to any number and type of financial data which is conventionally conveyed as linear, quantitative data. For example, other categories of financial information that may be conveyed to a subject in accordance with the subject methods include, but are not limited to bonds, cash, treasury notes, hedge funds, venture capital, stock options, commodities, insurance products (such as annuities), equity futures, derivatives such collaterized debt, precious metals, antiques, coins, stamps, and combinations thereof, among others.

In certain embodiments, methods include displaying more than one category of financial information, such as two or more categories of financial information, such as three or more categories of financial information and including 5 or more categories of financial information. In certain instances, methods include displaying between 2 and 10 categories of financial information, such as 3 to 9 categories of financial information, such as 4 to 8 categories of financial information and including displaying between 5 to 7 categories of financial information. This may be accomplished for example using a display (e.g., video monitor) which has 2 separate displays, split screens or sections to display linear and non-linear representations of the financial information, such as in a display on a smartphone, tablet computer, personal computer, laptop, or television. Non-linear representations displayed together pertaining to each category of financial information may be based on a correlation of the linear, quantitative financial information with the same or different secondary factors or a combination thereof. For example one or more of the non-linear representations may be based on a correlation of the linear, quantitative financial information with market history, age of security, market region, market sector, company stability, current market trading value, interest rates, foreign market share, inflation and deflation, the presence of absence of government subsidies, reputation of fund manager, reputation of brokerage managing fund, government regulation, current world events, or exchange rates. In other instances, two more of the plurality of displayed non-linear representations may be provided based on a correlation of the secondary factors of investor interest and company stability with the linear, quantitative financial information data. In yet other instances, two or more of the plurality of displayed non-linear representations may be provided based on a correlation of the secondary factors of foreign investor interest and the presence or absence of government subsidies with the linear quantitative financial information data.

### User Activity Related Information

Other types of information that may be displayed in accordance with methods of the present disclosure may include information related to one or more user activities or user-device interactions. For example, in some embodiments, information related to one or more user activities may be information about the state of a device, e.g., an apparatus, system, etc. utilized by the user. The phrase “state of the device” is used broadly to refer to any aspect or parameter of the device of interest. Examples of device state information may include, but are not limited to information about speed, engine activity (e.g., revolutions per minute as read from a tachometer), altitude, temperature, energy consumption, battery life, fuel consumption, fuel levels, data signal strength, radio frequency strength, wi-fi connectivity, touch screen sensitivity, volume, display brightness, global positioning strength, turbo fuel levels, nitrous oxide fuel levels, tire conditions, and combinations thereof.

Device state information displayed in accordance with the invention includes a non-linear representation derived based on a correlation of the linear device state data with specific secondary factors previously identified as being relevant to the linear, quantitative device state information. Depending on the particular device state information conveyed, secondary factors may include, but are not limited to age of device, user confidence, ease of use, external conditions (e.g., road conditions, water conditions, air conditions, weather, visibility), knowledge about incidents in a nearby area, pre-existing defects in the device, quality of device, size of device, duration of usage, number of applications operated by the device, geographic location, among other secondary factors.

One or more of the above secondary factors may be correlated with the linear device state data to derive the non-linear representation displayed, such as 2 or more secondary factors, such as 3 or more secondary factors, such as 5 or more secondary factors, such as 10 or more secondary factors and including 25 or more secondary factors as desired. For example, the number of secondary factors employed to derive the non-linear representation may range from 1 to 50, such as from 2 to 45, such as from 5 to 40, such as from 10 to 35, such as from 15 to 30 and including from 20 to 30 secondary factors.

Non-linear representations may depend on the number and type of secondary factors correlated with the linear device state data. As such, methods according to certain embodiments include adjusting the number or type of secondary factors. Depending on the display protocol, the non-linear representation may be changed in real time or may be changed based on input in a separate distinct analysis.

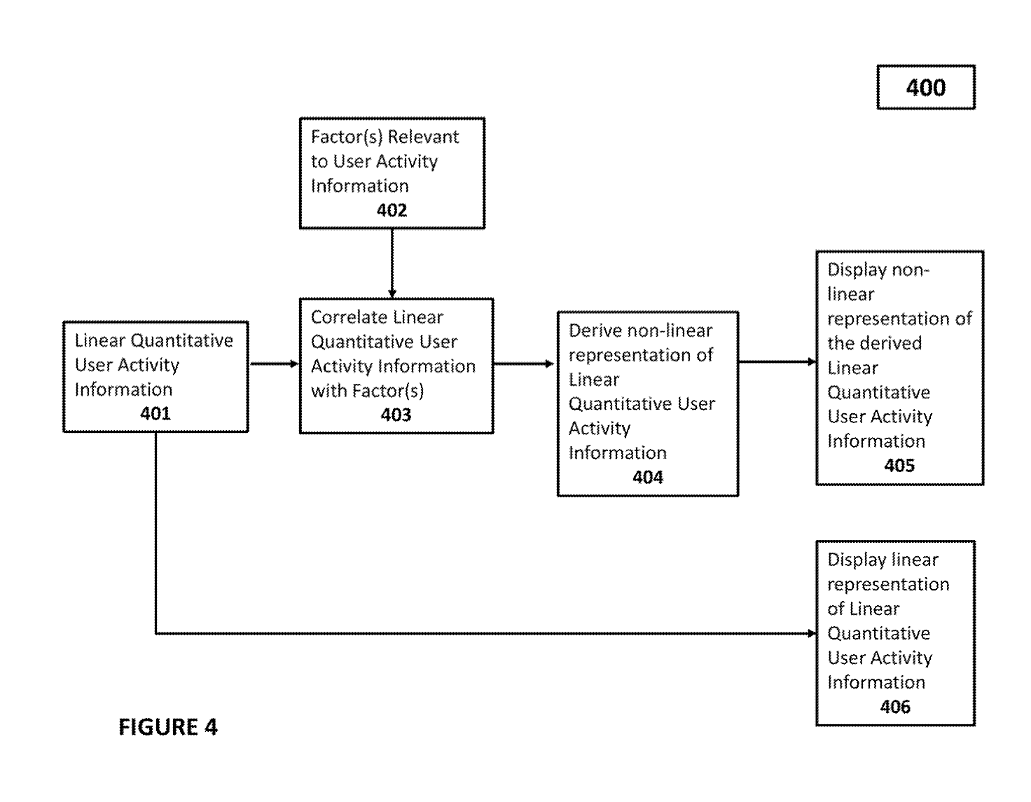

In some embodiments, a method of displaying user activity and/or user-device interaction information according to the present disclosure is a method (400) as depicted by the flow diagram of FIG. 4. The method generally includes the steps of: receiving linear, quantitative user activity and/or user-device interaction information (401), correlating (403) the received linear, quantitative user activity and/or user-device interaction information with one or more factors (402) previously identified as being relevant to the information, deriving a non-linear representation of the user activity and/or user-device interaction information based on the correlation between the user activity and/or user-device interaction information and the one or more factors (404), displaying a linear representation of the user activity and/or user-device interaction information (406), and displaying the non-linear representation of the user activity and/or user-device interaction information (405).

In some instances, a computer processor is employed to derive a non-linear representation of linear, quantitative user activity and/or user-device interaction information. A computer processor may be configured to perform one or more of the following functions: (1) receiving linear, quantitative user activity and/or user-device interaction information; (2) correlating the received linear, quantitative user activity and/or user-device interaction information with one or more factors previously identified as being relevant to the linear, quantitative user activity and/or user-device interaction information; (3) deriving a non-linear representation of the linear, quantitative user activity and/or user-device interaction information based on the correlation between the linear, quantitative user activity and/or user-device interaction information and the one or more factors; (4) causing a display to display a linear representation of the linear, quantitative user and/or user-device interaction activity information; and (5) causing a display to display the non-linear representation of the linear, quantitative user activity and/or user-device interaction information.

For example, in one embodiment the speed of a device (e.g., car, boat, plane, bicycle, motorcycle, etc.) may be conveyed by methods of the invention. The linear representation of the speed information, in certain instances may be displayed as a numerical value. In these embodiments, the speed is also displayed as a non-linear representation of speed taking into consideration one or more secondary factors related to and of significance to speed. For example, the non-linear representation of speed may be based on a correlation of the speed of the device (car, boat, plane, bicycle, motorcycle, etc.) with specific secondary factors such as age of device, user confidence, ease of use or pre-existing defects in the device, geographic location (including prior accidents in same location as provided from the NTSB database). The non-linear representation may be a display such as a risk assessment indicator or alarm. In certain instances, the non-linear representation is presented as an alarm which flashes lights and/or sounds an alarm at a non-linear rate as the speed of the device increases beyond a predetermined threshold. For example, the non-linear representation may be a flashing red light when the speed of the device (e.g., car) has increased beyond a speed of 60 miles per hour when correlated with information regarding poor external conditions (e.g., poor visibility or road conditions, weather conditions such as provided from a national weather service). As the speed of the device linearly increases beyond the predetermined threshold of 60 mph, the rate of flashing red light will increase at a non-linear rate, e.g., a logarithmic rate.

In another embodiment the energy consumption of a device may be conveyed by methods of the present disclosure. The linear representation of the energy consumption, in certain instances may be displayed as a numerical value or recognizable graphic representing energy consumption. In these embodiments, the energy consumption is also displayed as a non-linear representation of energy consumption taking into consideration one or more secondary factors related to and of significance to energy consumption. For example, the non-linear representation of energy consumption may be based on a correlation of the energy consumption of the device with specific secondary factors such as age of device, pre-existing defects in the device, number of applications operated by device, heat loss, etc. The non-linear representation may be a display such as a risk assessment indicator or alarm. In certain instances, the non-linear representation is presented as an alarm which flashes lights and sounds an alarm at a non-linear rate as the energy consumption of the device increases beyond a predetermined threshold. For example, the non-linear representation may be a flashing red light when the energy consumption is correlated with information such as significant heat loss, large number operating applications, or a device of significant age. As the energy consumption of the device linearly increases, the rate of flashing red light will increase at a non-linear, e.g., logarithmic, rate.

In yet another embodiment the temperature of a device may be conveyed by methods of the present disclosure. The linear representation of the temperature, in certain instances may be displayed as a numerical value or recognizable graphic representing a range of temperatures. In these embodiments, the temperature is also displayed as a non-linear representation of temperature taking into consideration one or more secondary factors related to and of significance to temperature. For example, the non-linear representation of temperature may be based on a correlation of the temperature of the device with specific secondary factors such as age of device, pre-existing defects in the device, number of applications operated by device, heat loss, etc. The non-linear representation may be a display such as a risk assessment indicator (such as to notify the user of possible malfunction or damage to the device) or alarm. In certain instances, the non-linear representation is presented as an alarm which flashes lights and sounds an alarm at a non-linear rate as the temperature of the device increases beyond a predetermined threshold. For example, the non-linear representation may be a flashing red light when the temperature is correlated with information such as a large number of operating applications, or duration of device usage. As the temperature of the device increases linearly, the rate of flashing red light will increase non-linearly, e.g., at a logarithmic rate.

In yet another embodiment the fuel level of a device (e.g., car, boat, plane, motorcycle) may be conveyed by methods of the invention. The linear representation of the fuel level information, in certain instances may be displayed as a numerical value or recognizable graphic representing a range of fuel levels. In these embodiments, the fuel level is also displayed as a non-linear representation of fuel level taking into consideration one or more secondary factors related to and of significance to fuel levels. For example, the non-linear representation of fuel level may be based on a correlation of the fuel level of the device with specific secondary factors such as age of device, duration of usage, type of usage and any pre-existing defects or conditions in the device, etc. The non-linear representation may be a display such as a risk assessment indicator (such as to notify the user of possible malfunction or damage to the device) or alarm. In certain instances, the non-linear representation is presented as an alarm which flashes lights and sounds an alarm at a non-linear rate as the fuel level of the device decreases beyond a predetermined threshold. For example, the non-linear representation may be a flashing red light when the fuel level is correlated with information such as age of device or any pre-existing defects or conditions in the device. As the fuel levels of the device decrease linearly, the rate of flashing red light will increase at a non-linear, e.g., logarithmic, rate.

In some instances, the device may be a transportation device, e.g., a plane, boat, automobile, etc. For example, an automobile may include a dashboard that includes both a conventional speedometer, which displays information about the speed of the automobile to the driver in a linear representation, as well as a second display which could be a circle that gets increasingly larger and/or changes color from green through yellow to red in a non-linear, e.g. an exponential, manner as the speed increases above a predetermined safe speed limit, e.g., 65 mph. This second display presents the non-linear representation of the information regarding the speed of the car to the driver, where the non-linear representation of the information may be one conveys to the user the exponentially heightened risk for each extra mile per hour over 65 miles per hour.

Like the above examples, non-linear representations of linear, quantitative information may be displayed in accordance with methods of the invention relating to any number and types of device state data which is conventionally conveyed as linear, quantitative data. For example, other categories of device state information that may be conveyed in accordance with the subject methods include, but are not limited to speed, engine activity (e.g., revolutions per minute as read from a tachometer), altitude, temperature, energy consumption, battery life, fuel consumption, fuel levels, data signal strength, radio frequency strength, wi-fi connectivity, touch screen sensitivity, volume, display brightness, global positioning strength, turbo fuel levels, nitrous oxide fuel levels, tire conditions, and combinations thereof, among others.

In certain embodiments, methods include displaying more than one category of device state information, such as two or more categories of device state information, such as three or more categories of device state information and including 5 or more categories of device state information. In certain instances, methods include displaying between 2 and 10 categories of device state information, such as 3 to 9 categories of device state information, such as 4 to 8 categories of device state information and including displaying between 5 to 7 categories of device state information. This may be accomplished for example using a display (e.g., video monitor) which has 2 separate displays, split screens or sections to display linear and non-linear representations of the device state information, such as in a display on a vehicle (car, boat, plane, motorcycle) dashboard, smartphone, tablet computer, personal computer, laptop, or television. Non-linear representations displayed together pertaining to each category of device state information may be provided based on a correlation of the same or different secondary factors or a combination thereof. For example one or more of the non-linear representations may be provided based on a correlation of linear, quantitative information with age of device, user confidence, ease of use, external conditions (e.g., road conditions, water conditions, air conditions, weather, visibility), pre-existing defects in the device, quality of device, size of device, duration of usage, number of applications operated by the device, among other secondary factors.

### Environmental Information

Another type of information that may be displayed in accordance with methods of the present disclosure may include environmental information. By “environmental information” is meant data associate with an environmental condition or property, e.g., of a specific geographic location. Examples of environmental information may include, but are not limited to information about the temperature, humidity, barometric pressure, air quality, visibility, winds, precipitation levels, UV index, amount of airborne allergens (e.g., pollen), concentrations of air pollutant (such as but not limited to ozone, carbon monoxide, nitrogen oxides, sulfur dioxides, lead, particulate matter, asbestos, benzene, catechol, chloroform, DDE, PCBs, Acetaldehyde, Acetamide, Acetonitrile, Acetophenone, 2-Acetylaminofluorene, Acrolein, Acrylamide, Acrylic acid, Acrylonitrile, Allyl chloride, 4-Aminobiphenyl, Aniline, o-Anisidine, Asbestos, Benzene (including benzene from gasoline), Benzidine, Benzotrichloride, Benzyl chloride, Biphenyl, Bis(2-ethylhexyl)phthalate, (DEHP), Bis(chloromethyl)ether, Bromoform, 1,3-Butadiene, Calcium cyanamide, Caprolactam (See Modification), Captan, Carbaryl, Carbon disulfide, Carbon tetrachloride, Carbonyl sulfide, Catechol, Chloramben, Chlordane, Chlorine, Chloroacetic acid, 2-Chloroacetophenone, Chlorobenzene, Chlorobenzilate, Chloroform, Chloromethyl methyl ether, Chloroprene, Cresols/Cresylic acid (isomers and mixture), o-Cresol, m-Cresol, p-Cresol, Cumene, 2,4-D, salts and esters, DDE, Diazomethane, Dibenzofurans, 1,2-Dibromo-3-chloropropane, Dibutylphthalate, 1,4-Dichlorobenzene(p), 3,3-Dichlorobenzidene, Dichloroethyl ether (Bis(2-chloroethyl)ether), 1,3-Dichloropropene, Dichlorvos, Diethanolamine, N,N-Dimethylaniline, Diethyl sulfate, 3,3-Dimethoxybenzidine, Dimethyl aminoazobenzene,3,3′-Dimethyl benzidine, Dimethyl carbamoyl chloride, Dimethyl formamide, 1,1-Dimethyl hydrazine, Dimethyl phthalate, Dimethyl sulfate, 4,6-Dinitro-o-cresol, and salts, 2,4-Dinitrophenol, 2,4-Dinitrotoluene, 1,4-Dioxane (1,4-Diethyleneoxide), 1,2-Diphenylhydrazine, Epichlorohydrin (1-Chloro-2,3-epoxypropane), 1,2-Epoxybutane, Ethyl acrylate, Ethyl benzene, Ethyl carbamate (Urethane), Ethyl chloride (Chloroethane), Ethylene dibromide (Dibromoethane), Ethylene dichloride (1,2-Dichloroethane), Ethylene glycol, Ethylene imine (Aziridine), Ethylene oxide, Ethylene thiourea, Ethylidene dichloride (1,1-Dichloroethane), Formaldehyde, Heptachlor, Hexachlorobenzene, Hexachlorobutadiene, Hexachlorocyclopentadiene, Hexachloroethane, Hexamethylene-1,6-diisocyanate, Hexamethylphosphoramide, Hexane, Hydrazine, Hydrochloric acid, Hydrogen fluoride (Hydrofluoric acid), Hydrogen sulfide (See Modification), Hydroquinone, Isophorone, Lindane (all isomers), Maleic anhydride, Methanol, Methoxychlor, Methyl bromide (Bromomethane), Methyl chloride (Chloromethane), Methyl chloroform (1,1,1-Trichloroethane), Methyl ethyl ketone (2-Butanone), methyl hydrazine, Methyl iodide (Iodomethane), Methyl isobutyl ketone (Hexone), Methyl isocyanate, Methyl methacrylate, Methyl tert butyl ether, 4,4-Methylene bis(2-chloroaniline), Methylene chloride (Dichloromethane), Methylene diphenyl diisocyanate (MDI), 4,4′-Methylenedianiline, Naphthalene, Nitrobenzene, 4-Nitrobiphenyl, 4-Nitrophenol, 2-Nitropropane, N-Nitroso-N-methylurea, N-Nitrosodimethylamine, N-Nitrosomorpholine, Parathion, Pentachloronitrobenzene (Quintobenzene), Pentachlorophenol, Phenol, p-Phenylenediamine, Phosgene, Phosphine, Phosphorus, Phthalic anhydride, Polychlorinated biphenyls (Aroclors), 1,3-Propane sultone, beta-Propiolactone, Propionaldehyde, Propoxur (Baygon), Propylene, dichloride (1,2-Dichloropropane), Propylene oxide, 1,2-Propylenimine (2-Methyl aziridine), Quinoline, Quinone, Styrene, Styrene oxide, 2,3,7,8-Tetrachlorodibenzo-p-dioxin, 1,1,2,2-Tetrachloroethane, Tetrachloroethylene (Perchloroethylene), Titanium tetrachloride, Toluene, 2,4-Toluene diamine, 2,4-Toluene diisocyanate, o-Toluidine, Toxaphene (chlorinated camphene), 1,2,4-Trichlorobenzene, 1,1,2-Trichloroethane, Trichloroethylene, 2,4,5-Trichlorophenol, 2,4,6-Trichlorophenol, Triethylamine, Trifluralin, 2,2,4-Trimethylpentane, Vinyl acetate, Vinyl bromide, Vinyl chloride, Vinylidene chloride (1,1-Dichloroethylene), xylenes (isomers and mixture including o-Xylenes, m-Xylenes, p-Xylenes), Antimony Compounds, Arsenic Compounds (inorganic including arsine), Beryllium Compounds, Cadmium Compounds, Chromium Compounds, Cobalt Compounds, Coke Oven Emissions, Cyanide Compounds, Glycol ethers, lead Compounds, Manganese Compounds, Mercury Compounds, Fine mineral fibers, Nickel Compounds, Polycyclic Organic Matter, Radionuclides (including radon), Selenium Compounds), concentrations of environmental water pollutants (such as but not limited to arsenic, mercury, copper, chromium, zinc, barium, volatile organic chemicals, methyl tert-butyl ether (MTBE), pesticides, plastics, detergents, acids, bases, caustics, radioactive uranium, thorium, cesium, iodine, radon, nitrates, phosphates, ammonium, antibiotics, asbestos, benzene, chlorine, cryptosproridium, chlorinates, fluoride, haloacetic acid, trihalomethanes), and combinations thereof.

Environmental information displayed in accordance with the methods of the present disclosure includes a non-linear representation derived based on a correlation of the linear environmental data with specific secondary factors previously identified as being relevant to the linear, quantitative environmental information. Depending on the particular environmental information conveyed, secondary factors may include, but are not limited to geographic location, time of day, season, altitude, presence or absence of cloud coverage, government regulations, government subsidies, historical trends, presence or absence of industrial factories, type of plants in geographic location, among other secondary factors.

One or more of the above secondary factors may be correlated with the linear environmental data to derive the non-linear representation displayed, such as 2 or more secondary factors, such as 3 or more secondary factors, such as 5 or more secondary factors, such as 10 or more secondary factors and including 25 or more secondary factors as desired. For example, the number of secondary factors employed to derive the non-linear representation may range from 1 to 50, such as from 2 to 45, such as from 5 to 40, such as from 10 to 35, such as from 15 to 30 and including from 20 to 30 secondary factors.

Non-linear representations may depend on the number and type of secondary factors correlated with the linear environmental data. As such, methods according to certain embodiments include adjusting the number or type of secondary factors. Depending on the display protocol, the non-linear representation may be changed in real time or may be changed based on input in a separate distinct analysis.

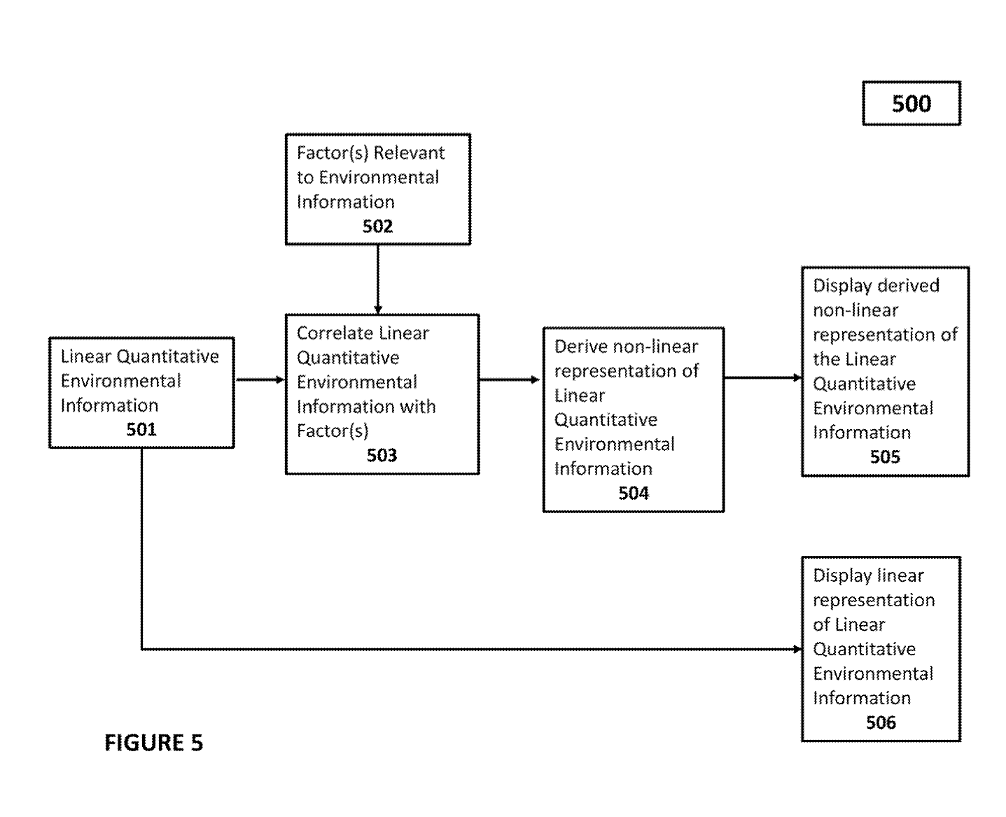

In some embodiments, a method of displaying environmental information according to the present disclosure is a method (500) as depicted by the flow diagram of FIG. 5. The method generally includes the steps of: receiving linear, quantitative environmental information (501), correlating (503) the received linear, quantitative environmental information with one or more factors (502) previously identified as being relevant to the information, deriving a non-linear representation of the environmental information based on the correlation between the user activity and/or user-device interaction information and the one or more factors (504), displaying a linear representation of the environmental information (506), and displaying the non-linear representation of the environmental information (505).

In some instances, a computer processor is employed to derive a non-linear representation of linear, quantitative environmental information. A computer processor may be configured to perform one or more of the following functions: (1) receiving linear, quantitative environmental information; (2) correlating the received linear, quantitative environmental information with one or more factors previously identified as being relevant to the linear, quantitative environmental information; (3) deriving a non-linear representation of the linear, quantitative environmental information based on the correlation between the linear, quantitative environmental information and the one or more factors; (4) causing a display to display a linear representation of the linear, quantitative environmental information; and (5) causing a display to display the non-linear representation of the linear, quantitative environmental information.

For example, in one embodiment the UV index may be conveyed by methods of the present disclosure. The linear representation of UV index, in certain instances, may be displayed as a numerical value or a table of numerical values over the course of a period of time. In these embodiments, the UV index is also displayed as a non-linear representation of UV index taking into consideration one or more secondary factors related to and of significance to UV indices. For example, the non-linear representation of UV index may be based on a correlation of the linear UV index data with specific secondary factors such as cloudiness, altitude and temperature.

The non-linear representation may be displayed as an assessment (i.e., report) which presents the linear, quantitative UV index data in the context of the secondary factors. This may take the form of a health risk assessment. In certain instances, the non-linear representation is presented as a gradient that changes colors in a non-linear manner depending on whether the UV index is above or below a predetermined threshold, such as value associated with adverse health effects. In some instances, where one secondary factor is cloudiness, the non-linear representation may be a display of increased escalation of health risks due to UV exposure when in the context of the cloudiness. For example, the non-linear representation may be a flashing red light when the UV index is 4 or greater when correlated with little to no cloudiness. On the other hand, the non-linear representation may be a flashing green light when the UV index is 6 or lower when correlated with a high level of cloudiness.

In another embodiment, the pollen allergy index may be conveyed by methods of the invention. The linear representation of pollen allergy index, in certain instances, may be displayed as a numerical value or a table of numerical values over the course of a period of time. In these embodiments, the pollen allergy index displayed as a non-linear representation of pollen allergy index taking into consideration one or more secondary factors related to and of significance to pollen allergy indices. For example, the non-linear representation of pollen allergy index may be based on a correlation of the linear pollen allergy index data with specific secondary factors such as geographic location, winds, humidity and altitude.

The non-linear representation may be displayed as an assessment (i.e., report) which presents the linear, quantitative pollen allergy index data in the context of the secondary factors. This may take the form of a health risk assessment. In certain instances, the non-linear representation is presented as a gradient that changes colors in a non-linear manner depending on whether the pollen allergy index is above or below a predetermined threshold, such as value associated with adverse health effects. In some instances, where one secondary factor is geographic location, the non-linear representation may be a display of increased escalation of health risks due to pollen exposure when in the context of the relative humidity. For example, the non-linear representation may be a flashing red light when the pollen allergy index is 6 or greater when correlated to a low relative humidity. On the other hand, the non-linear representation may be a flashing green light when the pollen allergy index is 8 or lower when correlated with a high relative humidity.

In another embodiment the environmental temperature may be conveyed by methods of the invention. The linear representation of the environmental temperature, in certain instances, may be displayed as a numerical value or a table of numerical values over the course of a period of time. In these embodiments, the temperature is also displayed as a non-linear representation of temperature taking into consideration one or more secondary factors related to and of significance to the environmental temperature. For example, the non-linear representation of the environmental temperature may be based on a correlation of the linear environmental temperature data with specific secondary factors such as geographic location, time of day, season, altitude and presence or absence of cloud coverage.

The non-linear representation may be displayed a report which presents the linear, quantitative environmental temperature data in the context of the secondary factors. This may take the form of a historical or predicted weather forecast. In certain instances, the non-linear representation is presented as a gradient of colors or logarithmic scale of numbers that changes as the temperature increases or decreases below a predetermined threshold, such as a temperature of historical significance. In some instances, where one secondary factor is season, the non-linear representation may be a display of increased escalation of global warming risk when in the context of the season. For example, the non-linear representation may be a non-linear graph which displays temperature data as a function of season and geographic location, altitude and time of day. If the temperature increases beyond a predetermined threshold such as the record historical high temperature, the non-linear representation may display an indication of the possibility of global warming in that region.

In another embodiment, the daily amount of environmental air pollutants (may be conveyed by methods of the invention. The linear representation of the daily amount of environmental air pollutants, in certain instances, may be displayed as a numerical value or a table of numerical values over the course of a period of time. In these embodiments, the amount of environmental air pollutants are also displayed as a non-linear representation of amount of environmental air pollutants taking into consideration one or more secondary factors related to and of significance to environmental air pollutants. For example, the non-linear representation of the environmental air pollutants may be provided based on a correlation of the linear environmental air pollutant data with specific secondary factors such as temperature, barometric pressure, humidity, geography, altitude, proximity of industrial factories and winds.

The non-linear representation may be displayed as an assessment (i.e., report) which presents the linear, quantitative environmental air pollutant data in the context of the secondary factors. This may take the form of a health risk assessment or as a depiction of long-term projected environmental outlook for air pollutants. In certain instances, the non-linear representation is presented as a gradient that changes colors in a non-linear manner as the amount of environmental air pollutants increase or decrease below a predetermined threshold, such as value associated with adverse health effects. In some instances, where one secondary factor is proximity to an industrial factory, the non-linear representation may be a display of increased escalation of health risks due to environmental air pollutants when in the context of proximity to an industrial factory. For example, the non-linear representation may be a flashing red light when the amount of total environmental air pollutants reaches above 1000 ppm when correlated with a short distance to an industrial factory. On the other hand, the non-linear representation may be a flashing green light when the amount of total environmental air pollutants reaches below 1000 ppm when correlated with a far distance to an industrial factory.

Yet another type of information that can be displayed in both linear and non-linear representations to a user is information about an environmental condition of a location. For example, information regarding the temperature, humidity and pressure of a geographical location may be presented to the user in the form of linear scales. In addition, the information may be presented to the user in a non-linear representation of the information, e.g., as described above, when the three values are such as to predict the occurrence of adverse weather conditions, e.g., thunderstorms or tornadoes.

Like the above examples, non-linear representations of linear, quantitative information may be displayed in accordance with methods of the invention relating to any number and type of environmental information which is conventionally conveyed as linear, quantitative data. For example, other categories of environmental information that may be conveyed in accordance with the subject methods include, but are not limited to temperature, humidity, barometric pressure, air quality, visibility, winds, precipitation levels, UV index, amount of airborne allergens (e.g., pollen), concentrations of specific air pollutants and concentrations of specific environmental water pollutants, and combinations thereof, among others.

In certain embodiments, methods include displaying more than one category of environmental information, such as two or more categories of environmental information, such as three or more categories of environmental information and including 5 or more categories of environmental information. In certain instances, methods include displaying between 2 and 10 categories of environmental information, such as 3 to 9 categories of environmental information, such as 4 to 8 categories of environmental information and including displaying between 5 to 7 categories of environmental information. This may be accomplished for example using a display (e.g., video monitor) which has 2 separate displays, split screens or sections to display linear and non-linear representations of the environmental information, such as in a display on a smartphone, tablet computer, personal computer, laptop, or television. Non-linear representations displayed together pertaining to each category of environmental information may be based on a correlation with the same or different secondary factors or a combination thereof. For example one or more of the non-linear representations may be based on a correlation of linear, quantitative information with geographic location, time of day, season, altitude, presence or absence of cloud coverage, government regulations, government subsidies, historical trends, presence or absence of industrial factories, or type of plants in geographic location. In other instances, two more of the plurality of displayed non-linear representations may be based on a correlation of the secondary factors of temperature and relative humidity with the linear, quantitative environmental information data. In yet other instances, two or more of the plurality of displayed non-linear representations may be based on a correlation of the secondary factors of pollen allergy index and UV index with the linear quantitative environmental information data.

Display Methods and/or Devices

In some instances, the linear and non-linear representations of the information may be presented to the user in a combined format. In yet other instances, the non-linear representation is distinct from the linear representation. For example, a dashboard on an automobile may include separate displays for both the linear and non-linear information of the speed of the automobile.

The linear and/or non-linear representations of the information may be displayed to the user using any convenient format and may be configured to be perceived by a user using any convenient sense or combination of senses, including two or more the senses, e.g., three or more senses, four or more senses or even all five senses, e.g., so that any one of or combination of two or more of sight (visual), hearing (auditory), taste, smell (olfactory) and touch (tactile) may be employed. In some instances, the linear and non-linear representations are displayed to a user by a visual display. Any convenient visual display may be employed, including but not limited to a graphical user interface, e.g., of a desk top computer, hand-held computer, smart phone or mobile device, e.g., iPhone®, iPad®, tablet computer, or Android® device, and the like. In some instances, the non-linear representation includes a visual aspect, a color and/or shape. In some instances, the non-linear representation comprises an auditory aspect.

While the above embodiments provide examples of non-linear representations of information derived from correlating linear, quantitative data with one or more secondary factors, the examples above are not meant to be limiting. Any of a number of non-linear representations may be employed in methods of the invention and may include but are not limited to: a display of lights or other visual signals flashing in a non-linear manner, gradient color changes, discrete color changes, patterned color changes, animations having a non-linear frequency or pattern, vibrations which increase or decrease in a non-linear manner, auditory alarms with sounds which increase or decrease in a non-linear manner, auditory alarms which change in a non-linear manner, visual patterns which change in a non-linear manner, cartoon animations, etc.

The linear and non-linear representation of the data may be displayed using any convenient display, such as for example, a video monitor which has 2 separate displays, split screens or sections to display linear and non-linear representations of the environmental information, such as in a display on a smartphone, tablet computer, personal computer, laptop, stock ticker, or television. As noted above, the display may display the linear and non-linear representation of the data on the same or different sections of the display (e.g., on separate screens or in the same section of the same screen). Likewise, more than one type of information (e.g., health-related information, financial information, user device information, environmental information), as described above, may be displayed simultaneously or in sequential fashion (such as by a series of screenshots or “click” through pages) on the display. As such, two or more types of information may be displayed simultaneously or sequentially by methods of the invention, such as three or more types of information, such as four or more types of information, such as five or more types of information, such as ten or more types of information, such as twenty-five or more types of information and including fifty or more types of information. The types of information from any of the above categories may be displayed together, as desired, such as displaying linear and non-linear representations of financial information with linear and non-linear representations of environmental data. For example, a computer desktop, tablet computer or smartphone may be configured to display linear and non-linear representations of environmental conditions (e.g., temperature, allergen conditions) and financial information (e.g., specific stock prices or real-time precious metal trading values).

The display of linear and non-linear representations of information according to methods of the invention may be in real-time or may be displayed in a discrete manner such as requiring the execution of a command before the linear or non-linear representations are displayed, such as for example after inputting and changing any desired parameters. Alternatively, some types of information may be displayed in real-time while others require execution of a command for display. For example, the linear representation may be displayed in real time while the non-linear representation is displayed only after inputting and accepting commands for display.

Aspects of the invention further include devices configured to display information to a user in both a linear and non-linear representation. The devices may or may not include a processor configured to provide the linear and non-linear representations of the information to a user.

In one embodiment, a device configured to display information to a user in both a linear and non-linear representation as described herein may be one which incorporates the Glass™ wearable computer technology provided by Google, Inc., Mountain View, Calif., e.g., as described in U.S. Patent Application Publication Nos. 2013/0021658, 2013/0022220, 2013/0021374, 2013/0021269, 2013/0007672, and 2012/0290401, the disclosure of each of which is incorporated by reference herein in its entirety.

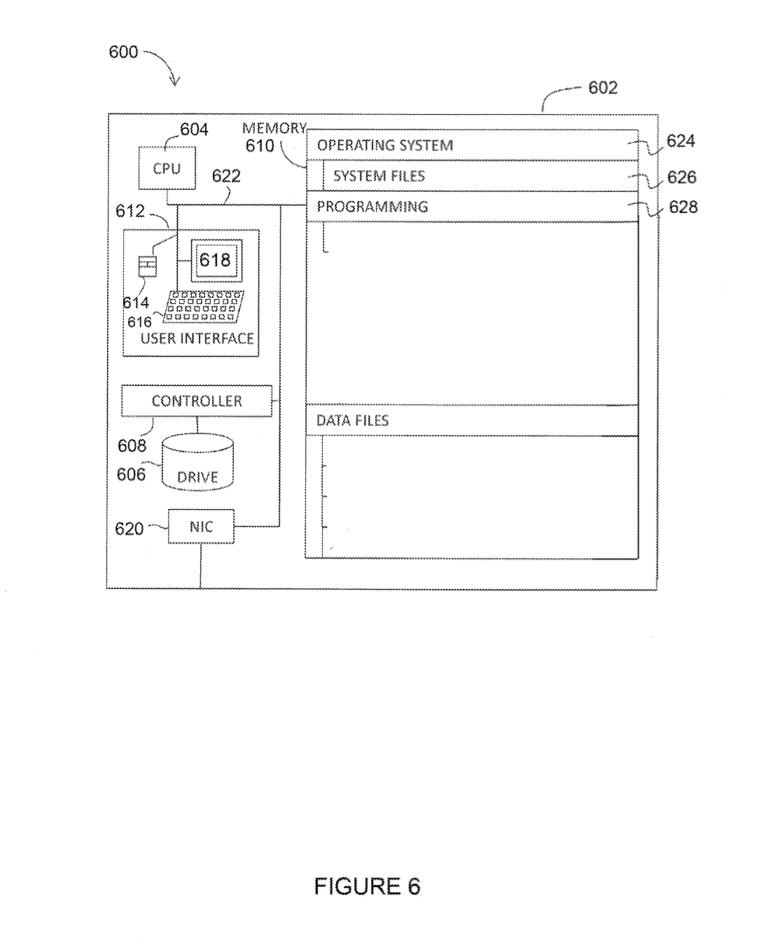

Aspects of the invention further include systems for displaying information to a user. In some instances, the system includes an executable program for receiving the information of interest; and displaying both a linear and a non-linear representation of the information the user. FIG. 6 illustrates an embodiment of a system 100 that can be employed in connection with the methods described above. As would be recognized by one of skilled in the art, many different hardware options and data structures can be employed to implement the methods described herein. The system illustrated in FIG. 6 is, therefore, exemplary and is not limiting.

Substantially any general-purpose computer can be configured to a functional arrangement for the methods and programs disclosed herein. The hardware architecture of such a computer is well known by a person skilled in the art, and can comprise hardware components including one or more processors (CPU), a random-access memory (RAM), a read-only memory (ROM), an internal or external data storage medium (e.g., hard disk drive). A computer system can also comprise one or more graphic boards for processing and outputting graphical information to display means. The above components can be suitably interconnected via a bus inside the computer. The computer can further comprise suitable interfaces for communicating with general-purpose external components such as a monitor, keyboard, mouse, network, etc. In some embodiments, the computer can be capable of parallel processing or can be part of a network configured for parallel or distributive computing to increase the processing power for the present methods and programs. In some embodiments, the program code read out from the storage medium can be written into a memory provided in an expanded board inserted in the computer, or an expanded unit connected to the computer, and a CPU or the like provided in the expanded board or expanded unit can actually perform a part or all of the operations according to the instructions of the program code, so as to accomplish the functions described below. In other embodiments, the method can be performed using a cloud computing system. In these embodiments, the data files and the programming can be exported to a cloud computer, which runs the program, and returns an output to the user.

System 600 can in certain embodiments comprise a computer 602 that includes: a) a central processing unit 604; b) a main non-volatile storage drive 606, which can include one or more hard drives, for storing software and data, where the storage drive 606 is controlled by disk controller 608; c) a system memory 610, e.g., high speed random-access memory (RAM), for storing system control programs, data, and application programs, including programs and data loaded from non-volatile storage drive 606; d) system memory 610 can also include read-only memory (ROM); a user interface 612, including one or more input or output devices, such as a mouse 614, a keypad 616, and a display 618; e) an optional network interface card 620 for connecting to any wired or wireless communication network, e.g., a printer; and f) an internal bus 622 for interconnecting the aforementioned elements of the system.

The memory of a computer system can be any device that can store information for retrieval by a processor, and can include magnetic or optical devices, or solid state memory devices (such as volatile or non-volatile RAM). A memory or memory unit can have more than one physical memory device of the same or different types (for example, a memory can have multiple memory devices such as multiple drives, cards, or multiple solid state memory devices or some combination of the same). With respect to computer readable media, “permanent memory” refers to memory that is permanent. Permanent memory is not erased by termination of the electrical supply to a computer or processor. Computer hard-drive ROM (i.e., ROM not used as virtual memory), CD-ROM, floppy disk and DVD are all examples of permanent memory. Random Access Memory (RAM) is an example of non-permanent (i.e., volatile) memory. A file in permanent memory can be editable and re-writable.

Operation of computer 602 is controlled primarily by operating system 624, which is executed by central processing unit 604. Operating system 624 can be stored in system memory 610. In some embodiments, operating system 624 includes a file system 626. In addition to operating system 624, one possible implementation of system memory 610 includes a variety programming files 628 and data files 630 for implementing the method described above.

In use, information of interest is input into and/or received by the system, and a user receives both a linear and non-linear representation of the information from the system.

In certain embodiments, instructions in accordance with the method described herein can be coded onto a computer-readable medium in the form of “programming”, where the term “computer readable medium” as used herein refers to any storage or transmission medium (including non-transitory versions of same) that participates in providing instructions and/or data to a computer for execution and/or processing. Examples of storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer.

The computer-implemented method described herein can be executed using programming that can be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method of displaying information to a user, the method comprising:
receiving linear, quantitative information;
correlating with a computer processor the received linear, quantitative information with one or more factors previously identified as being relevant to the linear, quantitative information;
deriving a non-linear representation of the linear, quantitative information based on the correlation between the linear, quantitative information and the one or more factors;
displaying a linear representation of the linear, quantitative information; and
displaying the non-linear representation of the linear, quantitative information.

2. The method according to claim 1, wherein one or more factors comprise risk data.

3. The method according to claim 1, wherein the one or more factors comprise relevance data.

4. The method according to claim 1, wherein the one or more factors comprise reward data.

5. The method according to claim 1, wherein the linear, quantitative information comprises information about a state of a device.

6. The method according to claim 5, wherein the information about the state of the device comprises a rate measure of the device.

7-25. (canceled)

26. A system for displaying information to a user, the system comprising:
a computer processor configured to:
receive the linear, quantitative information;
correlate the received linear, quantitative information with one or more factors previously identified as being relevant to the linear, quantitative information; and
derive a non-linear representation of the linear, quantitative information based on the correlation between the linear, quantitative information and the one or more factors; and
one or more displays in communication with the computer processor,
wherein the one or more displays display a linear representation of the linear, quantitative information and the non-linear representation of the linear, quantitative information.

27. The system of claim 26, comprising a first display and a second display, wherein the first display displays a linear representation of the linear, quantitative information and the second display displays the non-linear representation of the linear, quantitative information.

28. The system according to claim 26, wherein the linear representation of the linear, quantitative information and the non-linear representation of the linear, quantitative information are displayed simultaneously.

29. The system according to claim 26, wherein one or more factors comprise risk data.

30. The system according to claim 26, wherein the one or more factors comprise relevance data.

31. The system according to claim 26, wherein the one or more factors comprise reward data.

32. The system according to claim 26, wherein the linear, quantitative information comprises information about a state of a device.

33. The system according to claim 32, wherein the information about the state of the device comprises a rate measure of the device.

34-52. (canceled)

53. A non-transitory computer readable storage medium for displaying information to a user, the medium comprising an executable program which when executed by a computer processor causes the computer processor to:
receive linear, quantitative information;
correlate the received linear, quantitative information with one or more factors previously identified as being relevant to the linear, quantitative information; and
derive a non-linear representation of the linear, quantitative information based on the correlation between the linear, quantitative information and the one or more factors.

54. The non-transitory computer readable storage medium according to claim 53, wherein one or more factors comprise risk data.

55. The non-transitory computer readable storage medium according to claim 53, wherein the one or more factors comprise relevance data.

56. The non-transitory computer readable storage medium according to claim 53, wherein the one or more factors comprise reward data.

57. The non-transitory computer readable storage medium according to claim 53, wherein the linear, quantitative information comprises information about a state of a device.

58. The non-transitory computer readable storage medium according to claim 57, wherein the information about the state of the device comprises a rate measure of the device.

59-77. (canceled)
